(19) United States
(12) Patent Application Publication
(10) Pub. No.: US 2016/0192710 A1
(43) Pub. Date: Jul. 7, 2016

(54) ATOMIZATION ASSEMBLY AND ELECTRONIC CIGARETTE

(71) Applicant: HUIZHOU KIMREE TECHNOLOGY CO., LTD, Huizhou (CN)

(72) Inventor: Qiuming LIU, Huizhou (CN)

(73) Assignee: HUIZHOU KIMREE TECHNOLOGY CO., LTD, Huizhou (CN)

(21) Appl. No.: 15/068,825

(22) Filed: Mar. 14, 2016

Related U.S. Application Data
(63) Continuation of application No. PCT/CN2014/092451, filed on Nov. 28, 2014.

(51) Int. Cl. A24F 47/00; H05B 3/00; H05B 1/02

(52) U.S. Cl. CPC A24F 47/008; H05B 1/0244; H05B 3/0014

(57) ABSTRACT

An atomization assembly and an electronic cigarette are provided by the present application, the atomization assembly includes a liquid storage assembly and an atomization core assembly. The liquid storage assembly includes a liquid storage sleeve and a vapor pipe. The atomization core assembly includes an atomizing seat and an electric heating wire element. One end of the atomizing seat is covered with a cup cover, and an opening of the liquid storage chamber is covered by an end surface of the cup cover. A liquid guiding hole is provided at an area of the end surface of the cup cover, and a vapor hole is provided at an area of the end surface of the cup cover. A liquid guiding plate is provided at one side of the end surface of the cup cover. Thus, the liquid storage assembly and the atomization core assembly can be easily assembled.

### CROSS-REFERENCE TO RELATED APPLICATION

This application is a continuation of International Application No. PCT/CN2014/092451, titled “ATOMIZATION ASSEMBLY AND ELECTRONIC CIGARETTE”, filed on Nov. 28, 2014, the entire disclose of which is incorporated herein by this reference.

### TECHNICAL FIELD

The present application relates to the technical field of electronic cigarettes, and in particular to an atomization assembly and an electronic cigarette.

### BACKGROUND

An electronic cigarette is a new type electronic product which has an appearance and a flavor similar to a common cigarette, however, the electronic cigarette is healthier and more environmental friendly than a traditional cigarette.

In the conventional technology, a disposable atomizer of the electronic cigarette includes a liquid storage sleeve. A vapor pipe is provided in the liquid storage sleeve, and a liquid storage chamber is formed between the liquid storage sleeve and the vapor pipe. An atomization assembly further includes a mouthpiece and a heating element respectively arranged at two ends of the vapor pipe. In actual application, the electronic cigarette is further provided with other parts, such as a base for supporting the heating element, a sealing element for sealing the liquid storage chamber, liquid guiding cotton for guiding tobacco liquid in the liquid storage chamber into the heating element, etc.

During the production of the disposable atomizer of the electronic cigarette, after a worker injects the tobacco liquid into the liquid storage chamber, the heating element and other parts together with the liquid storage sleeve are assembled to form a complete disposable atomizer, and then the disposable atomizer is transported to a sales place to be sold. However, in the transportation process, tobacco liquid leakage may occur due to varied air pressure and temperature. Further, before the electronic cigarette is used, the tobacco liquid may be stored too long and further cause a deterioration of tobacco liquid or cause the electronic cigarette being close to the quality guarantee period of the tobacco liquid when bought by a user, affecting the user experience. If the tobacco liquid is put into the disposable atomizer after the disposable atomizer is transported to the sales place, the disposable atomizer requires to be assembled again in a transport place. Since the disposable atomizer has many parts, assembling of the parts one by one may increase much labor cost.

### SUMMARY

An atomization assembly and an electronic cigarette are provided by the present application, whose liquid storage assembly and atomization core assembly may be separately transported and stored, thereby avoiding tobacco liquid leakage during the transportation and storage due to the tobacco liquid requires to be injected before transportation, and facilitating installing the liquid storage assembly and the atomization core assembly.

An atomization assembly is provided by the present application to be assembled with a battery assembly to form an electronic cigarette, which has a liquid storage assembly and an atomization core assembly.

The liquid storage assembly includes a liquid storage sleeve having a first end and a second end opposite to each other. A mouthpiece is provided at the first end of the liquid storage sleeve, and a liquid filling port is formed at an end surface of the second end of the liquid storage sleeve. A vapor pipe in communication with the mouthpiece is provided in the liquid storage sleeve, and a liquid storage chamber for storing the tobacco liquid is formed between the liquid storage sleeve and the vapor pipe.

The atomization core assembly includes an atomizing seat, an electric heating wire element supported in an atomization space at one end of the atomizing seat for atomizing the tobacco liquid, and an electric connection element fixed at another end of the atomizing seat for being electrically connected to the electric heating wire assembly. A cup cover connected to the atomizing seat in an insertion manner is provided at one end, where the electric heating wire assembly is provided, of the atomizing seat.

The end, where the cup cover is provided, of the atomization core assembly, is inserted into the liquid storage sleeve and abuts against the vapor pipe at one end away from the mouthpiece. An opening of the liquid storage is covered by an end surface of the cup cover. A liquid guiding hole is provided at the end surface of the cup cover corresponding to the liquid storage chamber. A vapor hole in communication with the vapor pipe and the atomization space is provided at the end surface of the cup cover corresponding to the vapor pipe. A liquid guiding plate is arranged at one side, away from the liquid storage chamber, of the end surface of the cup cover, and is made of a liquid-absorbable material. The liquid guiding plate fits the end surface of the cup cover and covers the liquid guiding hole, such that the tobacco liquid in the liquid storage chamber is guided into the electric heating wire assembly by the liquid guiding hole and the liquid guiding plate to be atomized.

In the atomization assembly, the atomizing seat includes an atomizing seat body and a connecting sleeve sleeved on an outer side wall of the atomizing seat body. The electric heating wire assembly is supported in the atomizing seat body. The connecting sleeve has one end extending out of one end, away from the liquid storage assembly, of the atomizing seat body, and a connection structure detachably connected to the battery assembly is provided at an inner side wall of the end of the connecting sleeve.

The cup cover includes an end wall having an end surface and a side wall formed by a periphery of the end wall extending towards the connecting sleeve, and the side wall is sleeved on the connecting sleeve by an interference fit. A position-limiting protruding portion abutting against an end portion of the side wall of the cup cover is provided at an outer side wall of the connecting sleeve, and the liquid guiding plate is clamped between one end, close to the liquid storage sleeve, of the connecting sleeve and the end surface of the cup cover.

In the atomization assembly, a first annular groove is provided at an outer side wall, in the liquid storage sleeve, of the connecting sleeve.

The atomization core assembly further includes a sealing ring which is sleeved on the first annular grove and elastically presses against an inner side wall of the liquid storage sleeve.

In the atomization assembly, the connecting sleeve and the liquid storage sleeve are connected in an insertion manner by an interference fit, and a clearance is formed between the side wall of the cup cover and the liquid storage sleeve, and a width of the clearance is less than 0.1 mm.

In the atomization assembly, the atomization core assembly further includes a sealing seat which is hollow and cylindrical on the whole, and has a first end and a second end opposite to each other.

The first end of the sealing seat is inserted into the vapor hole of the cup cover, and the second end abuts against one end of the vapor pipe. A diameter of an outer side wall of the second end of the sealing seat is greater than a diameter of an outer side wall of the first end, which allows an annular boss to be formed at an outer side wall of the sealing seat. The end surface of the cup cover presses against the annular boss to press the sealing seat onto the vapor pipe and elastically press against the vapor pipe.

In the atomization assembly, the liquid guiding plate is elastically sleeved on the first end of the sealing seat.

In the atomization assembly, the atomizing seat body is a polyvinyl chloride silicone fiberglass tube or a ceramic tube, and one end of the atomizing seat body is provided with two opposite and apart U-shaped concave portions, both of which extend in a side away from the mouth piece.

The electric heating wire assembly is of a U-shape, which includes a first end and a second end in parallel with each other, and a middle section for connecting the first end and the second end. The middle section of the electric heating wire assembly is supported at bottoms of the two U-shaped concave portions of the atomizing seat body, and the first end and the second end of the electric heating wire assembly are respectively located in the two U-shaped concave portions of the atomizing seat body, and end surfaces of the first end and the second end of the electric heating wire assembly are directed at areas, corresponding to the liquid storage chamber, on the end surface of the cup cover through the liquid guiding plate.

In the atomization assembly, the atomizing seat body is a polyvinyl chloride silicone fiberglass tube or a ceramic tube, and two opposite through-holes are provided apart on a side wall of the atomizing seat body.

The electric heating wire assembly is of a U-shape, which includes a first end and a second end in parallel with each other, and a middle section for connecting the first end and the second end. The middle section of an electric heating wire element passes through the two through-holes of the atomizing seat body, a first end and a second end of the electric heating wire assembly are located in parallel outside the side wall of the atomizing seat body, and end surfaces of the first end and the second end of the electric heating wire assembly are directed at areas, corresponding to a liquid storage chamber, on an end surface of a cup cover through the liquid guiding plate.

In the atomization assembly, the atomizing seat body is a polyvinyl chloride silicone fiberglass tube or a ceramic tube, and two opposite concave portions are provided apart at one end of the atomizing seat body.

An electric heating wire element is cylindrical, two ends of the electric heating wire assembly are supported in the two concave portions of the atomizing seat body, and end surfaces of a first end and a second end of the electric heating wire assembly are directed at areas, corresponding to the liquid storage chamber, on an end surface of the cup cover through the liquid guiding plate.

In the atomization assembly, a liquid collecting chamber in communication with the vapor pipe is provided in the mouthpiece, and an air outlet hole for flowing out of airflow is provided on a chamber wall of the liquid collecting chamber, which allows the condensed tobacco liquid to be collected in the liquid collecting chamber in the case that the vapor atomized by the electric heating wire assembly flows via the vapor pipe to the air outlet hole.

In the atomization assembly, an annular boss for isolating the tobacco liquid is provided at one side, which is at a periphery of the air outlet hole and faces to the vapor pipe, of the chamber wall of the liquid collecting chamber, and or a liquid-absorbable piece made of a liquid absorption material is provided in the liquid collecting chamber.

In the atomization assembly, a positioning column is arranged around one end, close to the mouthpiece, of the vapor pipe, and the vapor pipe runs through a center axis of the positioning column.

An outer side wall of the positioning column is inserted into the liquid storage sleeve and abuts against an inner side wall of the liquid storage sleeve to fix the vapor pipe to make the vapor pipe in parallel with the inner side wall of the liquid storage sleeve. A second annular groove is provided on the outer side wall of the positioning column, and a sealing ring elastically abutting against the inner side wall of the liquid storage sleeve is sleeved in the second annular groove.

In the atomization assembly, an air outlet hole is provided on a mouthpiece at a position corresponding to a center axis of the liquid storage sleeve, and an annular positioning boss extending along the center axis of the liquid storage sleeve is provided at one side, facing to the vapor pipe, of a periphery of the air outlet hole.

A positioning ring is provided at an end surface of one end, close to the mouthpiece, of the positioning column, and one end, away from the positioning column, of the positioning ring extends to the annular positioning boss of the mouthpiece and is sleeved on the annular positioning boss, and an inner side wall of the positioning ring and an outer side wall of the annular positioning boss are tightly clamped by an interference fit.

In the atomization assembly, the mouthpiece, the liquid storage sleeve and the vapor pipe are formed integrally.

In the atomization assembly, an annular position-limiting step is provided at a position, corresponding to the end surface of the cup cover, at an inner side wall of the liquid storage sleeve, and a periphery of the end surface of the cup cover presses against the position-limiting step.

In the atomization assembly, the liquid storage sleeve is made of a light-permeable material.

In the atomization assembly, multiple liquid guiding holes are provided, and the multiple liquid guiding holes are arranged around the vapor hole and form an annular shape.

In the atomization assembly, a diameter of each of the liquid guiding holes is less than 1.5 mm.

In the atomization assembly, an included angle formed between an extending direction of each of the liquid guiding holes and an extending direction of the liquid storage chamber is greater than 30 degrees.

An electronic cigarette is further provided by the present application, which includes a battery assembly and an atomization assembly connected to each other, and the atomization assembly herein is the atomization assembly according to any one of the above atomization assemblies.

According to the above technical solutions, the atomization assembly and the electronic cigarette according to the present application have following advantages.

In the present application, since one end, where the electric heating wire assembly is provided, of the atomizing seat is covered with the cup cover connected to the atomizing seat in an insertion manner, and the liquid guiding hole is provided at the area of the end surface of the cup cover corresponding to the liquid storage chamber, the cup cover can encase, the electric heating wire assembly and the liquid guiding plate located between the liquid guiding hole and the electric heating wire assembly, in the atomizing seat, and the electric connection assembly electrically connected to the electric heating wire assembly is fixed on the atomizing seat at one end away from the electric heating wire assembly, therefore every part in the atomization core assembly may be assembled to form a whole, in this way, the liquid storage assembly and the atomization assembly can be separately transported and stored. Before sales, only the liquid storage chamber is required to be filled with the tobacco liquid and then the atomization core assembly is inserted into the liquid storage sleeve of the liquid storage assembly, thus the whole assembling process is simple, and the liquid leakage occurring in the liquid storage chamber during the tobacco liquid transportation is avoided, and meanwhile fresh tobacco liquid can be filled into the liquid storage chamber just before sales, which improves user experience. Besides, since the tobacco liquid is guided via the cup cover at the opening at one end of the liquid storage chamber to the electric heating wire assembly to be atomized, thus the tobacco liquid in the liquid storage chamber can be fully atomized, thereby avoiding not fully atomizing the tobacco liquid and misleading the user to burn the electric heating wire assembly dry since the tobacco liquid is apt to accumulate at a bottom of an outer side wall of the atomizing seat when the tobacco liquid is guided from a middle portion of a lateral wall of the atomizing seat. And the liquid guiding plate fits the end surface of the cup cover and covers the liquid guiding hole, the liquid is guided to the electric heating wire assembly through the cooperation of the liquid guiding plate and the liquid guiding hole, thereby avoiding over delivering the tobacco liquid and tobacco liquid leaking into the atomizing seat, due to the electric heating wire assembly is directly inserted into the liquid storage chamber to guide liquid, and further preventing the user from smoking the leaked tobacco liquid.

### BRIEF DESCRIPTION OF THE DRAWINGS

FIG. 1 is a cross-sectional view showing the structure of an embodiment of an atomization assembly according to the present application;

FIG. 2 is a cross-sectional view showing the structure of the liquid storage assembly in the atomization assembly in FIG. 1;

FIG. 3 is a cross-sectional view showing the structure of the atomization core assembly in the atomization assembly in FIG. 1;

FIG. 4 is an exploded view of the atomization core assembly in FIG. 3;

FIG. 5 is a schematic view showing another structure of an atomizing seat body in the atomization core assembly according to the present application;

FIG. 6 is a cross-sectional view showing another structure of an atomization core assembly in the atomization assembly according to the present application;

FIG. 7 is a schematic view showing another structure of an atomizing seat body in the atomization core assembly in FIG. 6;

FIG. 8 is a cross-sectional view showing another structure of an atomization core assembly in the atomization assembly according to the present application;

FIG. 9 is a schematic view showing another structure of an atomizing seat body in the atomization core assembly in FIG. 8;

FIG. 10 is a cross-sectional view showing another structure of a liquid storage assembly in the atomization assembly according to the present application; and

FIG. 11 is a schematic view showing the structure of a vapor pipe, a positioning column, and a positioning ring in the liquid storage assembly in FIG. 10.

### DETAILED DESCRIPTION

An atomization assembly and an electronic cigarette are provided by the present application, whose liquid storage assembly and atomization core assembly may be transported and stored separately and assembled easily, thus tobacco liquid does not require to be filled before transportation and storage, which may otherwise cause tobacco liquid leakage during the transportation and storage.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

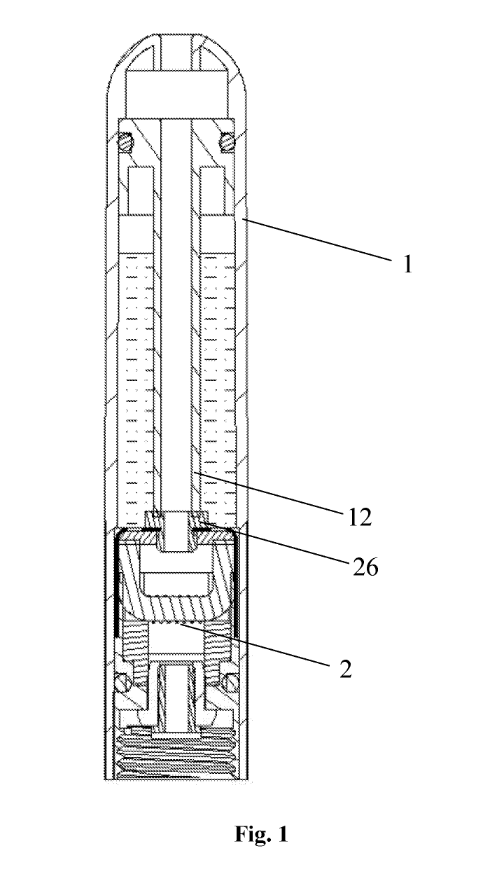

Reference is made to FIG. 1. FIG. 1 is a cross-sectional view showing the structure of an atomization assembly according to an embodiment of the present application. The atomization assembly in FIG. 1 is provided for combining with a battery assembly (not shown) to form an electronic cigarette. As shown in FIG. 1, the atomization assembly includes a liquid storage assembly 1 and an atomization core assembly 2.

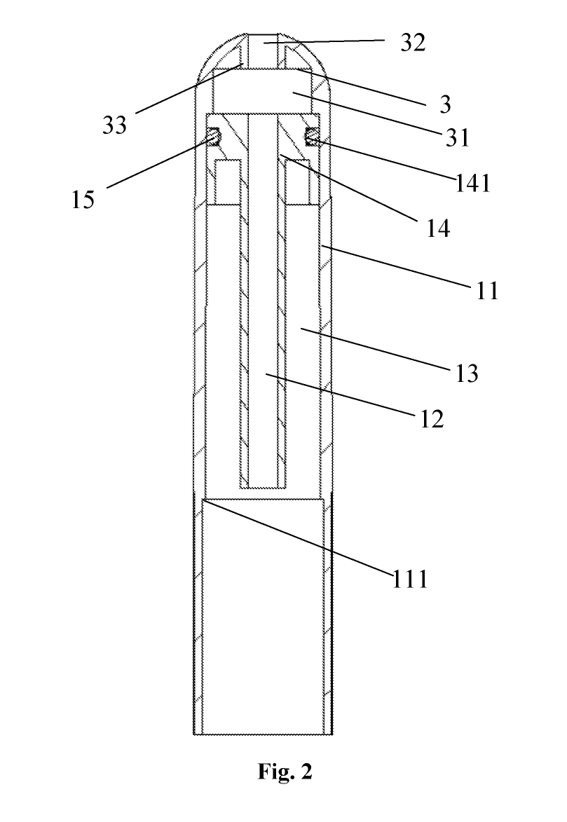

Reference is made to FIG. 2. FIG. 2 is a cross-sectional view showing the structure of the liquid storage assembly in the atomization assembly in FIG. 1. The liquid storage assembly 1 includes a liquid storage sleeve 11 having a first end and a second end which are opposite. A mouthpiece 3 is provided at the first end of the liquid storage sleeve 11, and a liquid filling port (a reference numeral thereof is not shown in Figure) is formed on an end surface of the second end of the liquid storage sleeve 11. In this embodiment, the mouthpiece 3 and the liquid storage sleeve 11 are formed integrally. Apparently, the mouthpiece 3 and the liquid storage sleeve 11 may also be formed in a detachable manner, which are not limited herein.

A vapor pipe 12, which has one end in communication with the mouthpiece 3 and another end extending towards the liquid filling port, is provided in the liquid storage sleeve 11. A liquid storage chamber 13 for storing the tobacco liquid is formed between the liquid storage sleeve 11 and the vapor pipe 12. Preferably, the liquid storage sleeve 11 is made of light-permeable material, so that a user can check the amount of the tobacco liquid remaining in the liquid storage chamber 13 conveniently.

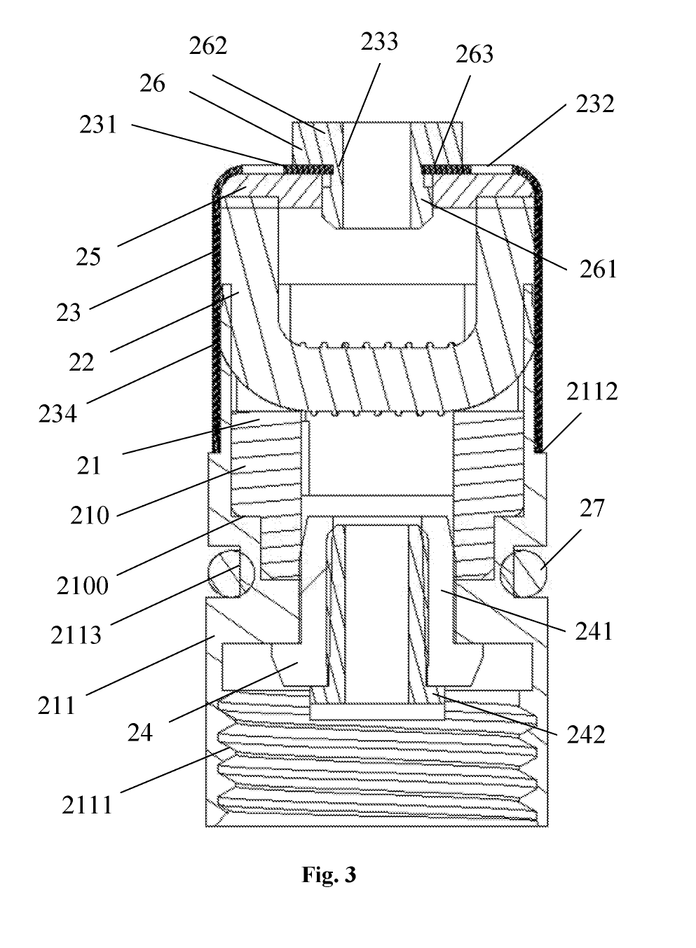

Reference is made to FIG. 3. FIG. 3 is a cross-sectional view showing the structure of the atomization core assembly in the atomization assembly in FIG. 1. The atomization core assembly 2 includes an atomizing seat 21, an electric heating wire element 22, a cup cover 23, an electric connection assembly 24 and a liquid guiding plate 25.

The electric heating wire element 22 is arranged in an atomizing space (a reference numeral thereof is not shown) at one end of the atomizing seat 21 for atomizing the tobacco liquid. The cup cover 23 is configured to cover an end, where the electric heating wire assembly 22 is provided, of the atomizing seat 21, and is connected to the atomizing seat 21 in an insertion manner for covering the electric heating wire assembly 22. The electric connection assembly 22 is fixed at another end of the atomizing seat 21 for being electrically connected to the electric heating wire assembly 22 and the battery assembly respectively, which allows the battery assembly to provide power for the electric heating wire assembly 22. The insertion connection manner between the cup cover 23 and the atomizing seat 21 may be realized by tightening through expanding or using the threaded connection, as long as the cup cover 23 and the atomizing seat 21 can be connected by insertion, and the specific insertion connection manner is not limited herein.

The end, where the cup cover 23 is provided, of the atomization core assembly 2, is inserted into the liquid storage sleeve 11 and abuts against the vapor pipe 12 at an end away from the mouthpiece 3. An opening of a liquid storage chamber 13 is covered by an end surface 231 of the cup cover 23 to allow the tobacco liquid to be stored in the liquid storage chamber 13.

The end surface 231 of the cup cover 23 is provided with a liquid guiding hole 232 at an area corresponding to the liquid storage chamber 13. The liquid guiding plate 25 is arranged at one side, away from the liquid storage chamber 13, of the end surface 231 of the cup cover 23. The liquid guiding plate 25 is made of a liquid-absorbable material. The liquid-absorbable material may be a sponge or fiber, which is not limited herein. The liquid guiding plate 25 fits the end surface 231 of the cup cover 23 and covers the liquid guiding hole 232, so that the tobacco liquid in the liquid storage chamber 13 is guided to the electric heating wire assembly 22 by the liquid guiding hole 232 and the liquid guiding plate 25 to be atomized.

A vapor hole 233 in communication with the vapor pipe 12 and the atomization space is provided in an area, corresponding to the vapor pipe 12, of the end surface 231 of the cup cover 23, so that vapor atomized by the electric heating wire assembly 22 at the atomization space enters the vapor pipe 12 via the vapor hole 233 and flow into the mouthpiece 3 and then is smoked by the user.

In this embodiment, since one end, where the electric heating wire assembly is provided, of the atomizing seat is covered with the cup cover connected to the atomizing seat in an insertion manner, and the area of the cup cover at the end surface corresponding to the liquid storage chamber is provided with the liquid guiding hole, the cup cover can encase the electric heating wire assembly and the liquid guiding plate between the liquid guiding hole and the electric heating wire assembly in the atomizing seat, and the electric connection assembly electrically connected to the electric heating wire assembly is fixed on the end, away from the electric heating wire assembly, of atomizing seat, therefore every part in the atomization core assembly may be assembled to form a whole, in this way, the liquid storage assembly and the atomization assembly can be separately transported and stored. Only the liquid storage chamber is required to be filled with the tobacco liquid and then the atomization core assembly is inserted into the liquid storage sleeve of the liquid storage assembly before sales. The whole assembling process is simple, and the tobacco liquid leakage in the liquid storage chamber during the transportation of the tobacco liquid is avoided, and meanwhile fresh tobacco liquid may be filled into the liquid storage chamber just before the sales, further improving user experience.

Besides, since the tobacco liquid is guided via the cup cover at the opening of the end of the liquid storage chamber to the electric heating wire assembly to be atomized, the tobacco liquid in the liquid storage chamber can be fully atomized, thereby avoiding not fully atomizing the tobacco liquid and misleading user to boil the electric heating wire assembly dry since the tobacco liquid is apt to accumulate at a bottom of an outer side wall of the atomizing seat when the tobacco liquid is guided from a middle portion of a lateral wall of the atomizing seat. Further, the liquid guiding plate fits the end surface of the cup cover and covers the liquid guiding hole, the liquid is guided to the electric heating wire assembly through the cooperation of the liquid guiding plate and the liquid guiding hole, thereby avoiding the electric heating wire assembly being directly inserted into the liquid storage chamber to guide liquid and thus easily causing over delivering of the tobacco liquid, which otherwise results in leakage of tobacco liquid into the atomizing seat, and further preventing the user from smoking the leaked tobacco liquid.

Preferably, multiple liquid guiding holes 233 are provided, and the liquid guiding holes 233 are arranged around the vapor hole 233 and form a ring shape. With such structure, the tobacco liquid can be uniformly guided to each area of the liquid guiding plate 25, thus avoiding the electric heating wire assembly 22 from burning out due to an unsmooth access to the tobacco liquid, and better avoiding the user from smoking an abnormal taste caused by burned electric heating wire assembly 22, and better protecting the health of the user.

Preferably, a diameter of each of the liquid guiding holes 232 is less than 1.5 mm, and more preferably, the diameter of each of the liquid guiding holes 232 is 1 mm, thus the tobacco liquid can be reasonably delivered and burning out or over delivering of the tobacco liquid is avoided.

Preferably, an included angle greater than 30 degrees is formed between an extending direction of each of the liquid guiding holes 232 and an extending direction of the liquid storage chamber 13. Due to such structure, the tobacco liquid leaked via the liquid guiding holes 232 is better reduced when the atomization assembly falls uprightly. Apparently, the included angle may be 45 degrees or 60 degrees, etc., which is not specifically limited herein.

Preferably, in this embodiment, an annular position-limiting step 111 (referring to FIG. 2) is provided at a position, corresponding to the end surface 231 of the cup cover 23, at an inner side wall of the liquid storage sleeve 11. When the atomization core assembly 2 is inserted into the liquid storage sleeve 11 and abuts against one end, away from the mouthpiece 3, of the vapor pipe 12, a periphery of the end surface 231 of the cup cover 23 presses against the position-limiting step 111. In this way, the end surface of the cup cover is just located at the opening of the liquid storage chamber when the atomization core assembly and the liquid storage assembly are assembled.

In this embodiment, one end of the vapor pipe 12 is in communication with the atomization space via the vapor hole 233 in the end surface 231 of the cup cover 23. Preferably, the atomization core assembly 2 further includes a sealing seat 26 for connecting one end of the vapor pipe 12 and the vapor hole 233, thus avoiding the tobacco liquid in the liquid storage chamber 13 from permeating the atomization space via the vapor hole 233.

As shown in FIGS. 1 and 3, in this embodiment, the sealing seat 26 is generally hollow and cylindrical, which has a first end 261 and a second end 262 opposite to each other. The first end 261 of the sealing seat 26 is inserted into the vapor hole 233 of the cup cover 23, and the second end 262 abuts against one end of the vapor pipe 12 and covers the opening of the vapor pipe 12. A diameter of an outer side wall of the second end 262 of the sealing seat 26 is diameter greater than a diameter of an outer side wall of the first end 261, which forms an annular boss 263 at an outer side wall of the sealing seat 26.

The end surface 231 of the cup cover 23 presses against the annular boss 263 to press the sealing seat 26 towards the vapor pipe 12 and elastically press against the vapor pipe 12. The vapor atomized by the electric heating wire assembly 22 in the atomization space flows into the vapor pipe 12 via a central hollow place of the sealing seat 26.

Apparently, the sealing seat in the atomization core assembly may be of other structure forms, which are not limited herein.

Preferably, the liquid guiding plate 25 is elastically sleeved on the first end 261 of the sealing seat, which may facilitate assembly and can allow the liquid guiding plate 25 to be reliably connected to the cup cover 23, thereby avoiding the liquid guiding plate 25 to fall off.

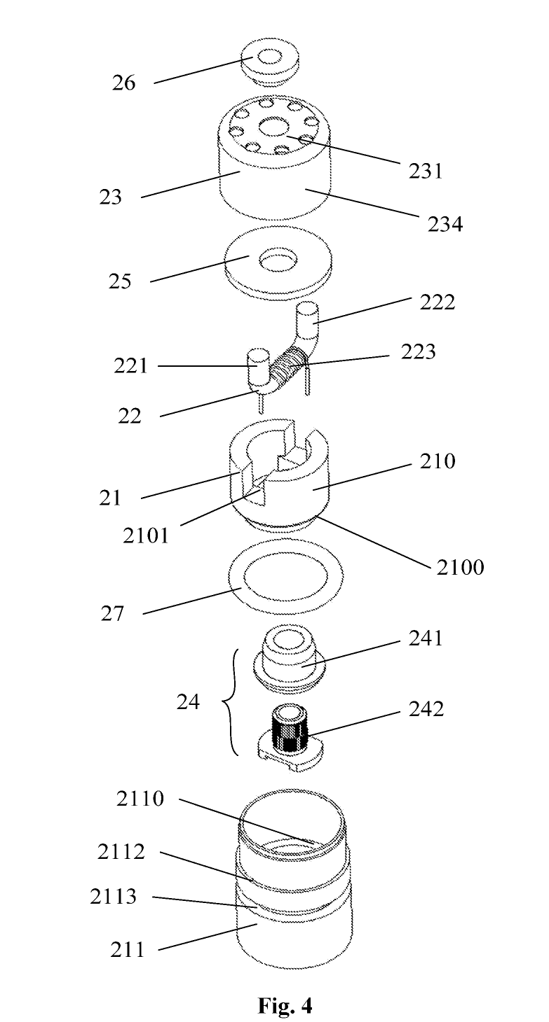

In this embodiment, the atomizing seat in the atomization core assembly may have multiple structure forms. A specific structure form of the atomizing seat in the atomization core assembly is described in conjunction with FIGS. 3 and 4 hereinafter. Reference is made to FIGS. 3 and 4, and FIG. 4 is an exploded view of the atomization core assembly in FIG. 3.

The atomizing seat 21 includes an atomizing seat body 210 and a connecting sleeve 211 sleeved on an outer side wall of the atomizing seat body 210. Preferably, a position-limiting boss 2110 is provided at an inner side wall of the connecting sleeve 211, a position-limiting boss 2100 is provided at the atomizing seat body 210, and the first position-limiting boss 2110 at the connecting sleeve 211 and the second position-limiting boss 2100 at the atomizing seat body 210 press against each other to fix the connecting sleeve 211 and the atomizing seat body 210 when the connecting sleeve 211 is sleeved on the outer side wall of the atomizing seat body 210. It will be appreciated that, the atomizing seat body 210 and the connecting sleeve 211 may be formed integrally, which is not limited herein.

The connecting sleeve 211 has an end extending out of one end, away from the liquid storage assembly 1, of the atomizing seat body 210, and a connection structure 2111 detachably connected to the battery assembly is provided at an inner side wall of the end of the connecting sleeve 211. Specifically, in this embodiment, the connection structure 2111 is of an internal threaded structure. Apparently, the connection structure 2111 may also be of a buckle structure buckled with the battery assembly, or other structures, which are not limited herein.

In this embodiment, the atomizing seat body 210 is hollow and annular. The electric heating wire assembly 22 is mounted on one end of the atomizing seat body 210. Apparently, in other embodiments of the present application, the atomizing seat body 210 may also be of other structures, which are not limited herein.

The cup cover 23 includes an end wall having the end surface 231 and a side wall 234 formed by a periphery of the end wall extending towards the connecting sleeve 211, and the side wall 234 is sleeved on the connecting sleeve 211 by an interference fit. A position-limiting protruding portion 2112 abutting against an end portion of the side wall 234 of the cup cover 23 is provided at an outer side wall of the connecting sleeve 211.

Preferably, one end, close to the liquid storage sleeve 11, of the connecting sleeve 211 extends to one side of the end surface 231 of the cup cover 23, and the liquid guiding plate 25 is clamped between one end, close to the liquid storage sleeve 11, of the connecting sleeve 211 and the end surface 231 of the cup cover 23. In this way, the liquid guiding plate 25 and the cup cover 23 can be reliably connected, avoiding the liquid guiding plate 25 falling off.

Preferably, a first annular groove 2113 is provided at an outer side wall, inside the liquid storage sleeve 11, of the connecting sleeve 211. The atomization core assembly 2 further includes a sealing ring 27 which is sleeved on the first annular grove 2113 and presses elastically against an inner side wall of the liquid storage sleeve 11, thus preventing the tobacco liquid in the liquid storage chamber 13 from exuding via a clearance between the inner side wall of the liquid storage sleeve 11 and an outer side wall of the atomization core assembly 2.

Preferably, the connecting sleeve 211 and the liquid storage sleeve 11 are connected in an insertion manner by interference fit, and a clearance is formed between the side wall 234 of the cup cover 23 and the liquid storage chamber 11, and a width of the clearance is less than 0.1 mm. Thus the atomization core assembly and the liquid storage assembly can be assembled easily and the tobacco liquid in the liquid storage chamber can be fully atomized.

In this embodiment, the atomizing seat can be formed in various structures and mounting the electric heating wire assembly on the atomizing seat can be achieved by various ways, and one of which is described in conjunction with FIGS. 3 and 4 hereinafter.

The atomizing seat body 210 is a polyvinyl chloride silicone fiberglass tube or a ceramic tube, and two opposite mounting grooves 2101 extending in one side away from the mouthpiece are provided apart in one end of the atomizing seat body 210.

The electric heating wire assembly 22 is of a U shape, which includes a first end 221 and a second end 222 in parallel with each other and a middle section 223 configured to connect the first end 221 and the second end 222. Two ends of the middle section 223 of the electric heating wire assembly 22 are respectively supported by bottoms of the two mounting grooves 2101 of the atomizing seat body 210. The first end 221 and the second end 222 of the electric heating wire assembly 22 are respectively located in the two mounting grooves 2101 of the atomizing seat body 210, and end surfaces of the first end 221 and the second end 222 of the electric heating wire assembly 22 are directed at areas, corresponding to the liquid storage chamber 13, on the end surface 231 of the cup cover 23 through the liquid guiding plate 25.

In this embodiment, the electric heating wire assembly is directly mounted in the mounting grooves of the atomizing seat body, which is easy to assemble.

Further, one end, away from the electric heating wire assembly 22, of the atomizing seat body 210 is configured to fix the electric connection assembly 24. Specifically, the electric connection assembly 24 includes an insulation piece 241 and an inner electrode 242, which is electrically connected to the battery assembly, and the insulation piece 241 and the inner electrode 242 are inserted into the central hollow space of the atomizing seat body 210 by interference fit from outside to inside. In this embodiment, the connecting sleeve 211 is an outer electrode electrically connected to the battery assembly.

It will be appreciated that, in other embodiments, the electric connection assembly 24 may be other conductive structures, for example, the connecting sleeve 211 is made of a non-conductive material, and the electric connection assembly 24 includes an outer electrode, an insulation piece and an inner electrode inserted into the central hollow space of the atomizing seat body 210 from outside to inside, and the outer electrode is electrically connected to the battery assembly, and the inner electrode is electrically connected to the battery assembly.

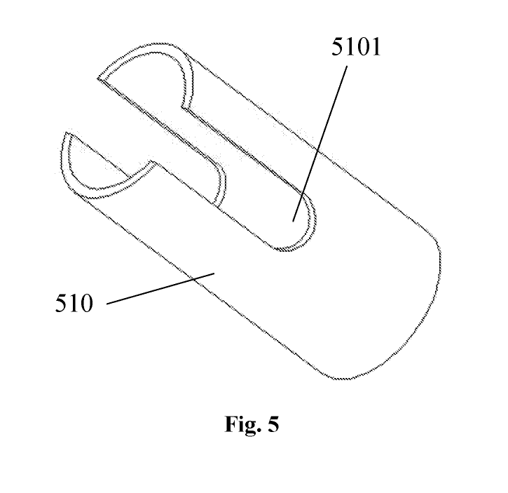

In actual application, the atomizing seat body 210 may also be of other structure forms. As shown in FIG. 5, FIG. 5 is a schematic view showing another structure of an atomizing seat body in the atomization core assembly according to the present application. Different with the atomizing seat body in the atomization core assembly in FIG. 4, in the atomizing seat body in the atomization core assembly in FIG. 5, in the atomizing seat body in FIG. 5, two opposite U-shaped concave portions 5101 both extending in a direction away from the mouth piece are provided apart at one end of the atomizing seat body 510. Different with FIG. 4, a middle section 223 of the electric heating wire assembly 22 is supported at bottoms of the two U-shaped concave portions 5101 of an atomizing seat body 210, and the first end 221 and the second end 222 of an electric heating wire element 22 are respectively located in the two U-shaped concave portions 5101 of the atomizing seat body 210.

In this embodiment, since the electric heating wire assembly 22 is generally cylindrical, the electric heating wire assembly 22 can fit the U-shaped concave portions more closely when mounted in the U-shaped concave portions, thereby preventing the electric heating wire assembly from waggling in the U-shaped concave portions.

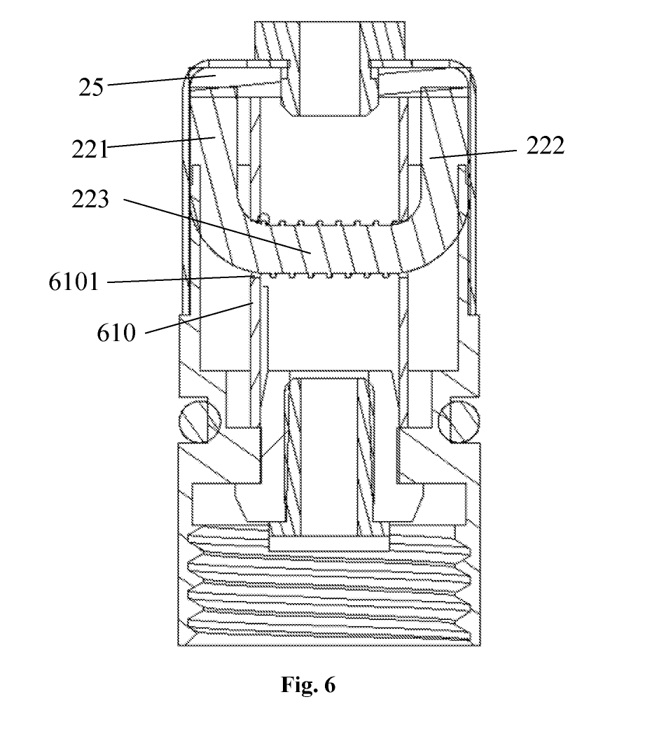

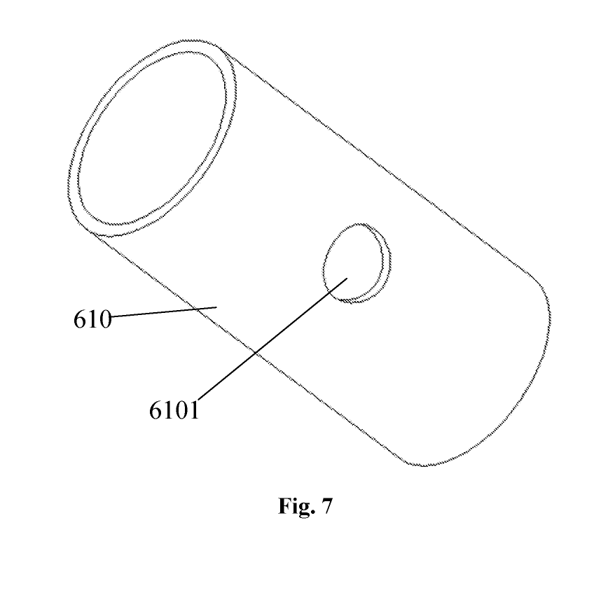

As shown in FIGS. 6 and 7, FIG. 6 is a cross-sectional view showing another structure of an atomization core assembly in the atomization assembly according to the present application, and FIG. 7 is a schematic view showing another structure of an atomizing seat body in the atomization core assembly in FIG. 6. Different with the atomization core assembly in FIG. 3, in this embodiment, two opposite through-holes 6101 are provided apart on a side wall of an atomizing seat body 610.

A middle section 223 of an electric heating wire element 22 passes through the two through-holes 6101 of the atomizing seat body 610. The first end 221 and the second end 222 of the electric heating wire assembly 22 are located in parallel outside the side wall of the atomizing seat body 610, and end surfaces of the first end 221 and the second end 222 of the electric heating wire assembly 22 are directed at areas, corresponding to a liquid storage chamber 13, on an end surface 231 of a cup cover 23 through a liquid guiding plate 25.

In this embodiment, the electric heating wire assembly and the atomizing seat body can be easily assembled, and the electric heating wire assembly can be fixed, preventing the electric heating wire assembly from waggling upward and downward.

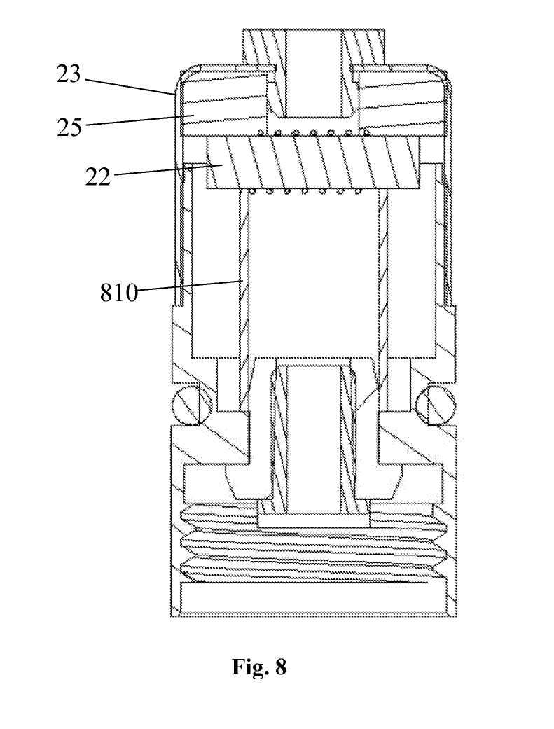

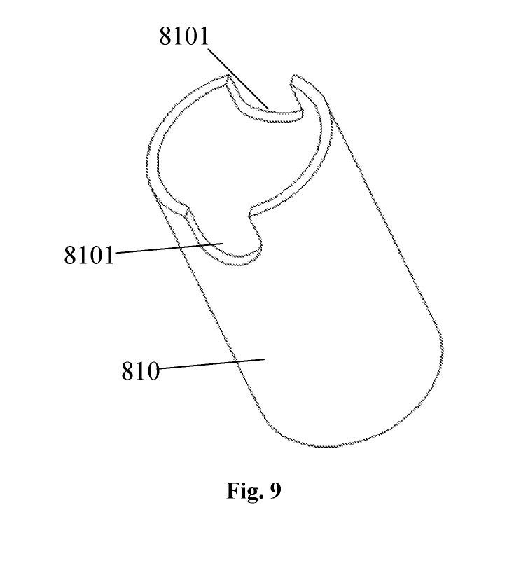

As shown in FIGS. 8 and 9, FIG. 8 is a cross-sectional view showing another structure of an atomization core assembly in the atomization assembly according to the present application, and FIG. 9 is a schematic view showing another structure of an atomizing seat body in the atomization core assembly in FIG. 8. Different with the atomization core assembly in FIG. 3, in this embodiment, two opposite concave portions 8101 are provided apart at one end of an atomizing seat body 810.

An electric heating wire element 22 is cylindrical, and two ends of the electric heating wire assembly 22 are supported on the two concave portions 8101 of the atomizing seat body 810, and end surfaces of a first end 221 and a second end 222 of the electric heating wire assembly 22 are directed at areas, corresponding to a liquid storage chamber 13, on an end surface 231 of a cup cover 23 through a liquid guiding plate 25.

In this embodiment, a distance for guiding liquid in the electric heating wire assembly is reduced, thereby increasing the liquid guiding efficiency, and preventing cotton in the electric heating wire assembly burning.

According to the present application, the mouthpiece 3 is arranged at the first end of the liquid storage sleeve 11. In actual application, the mouthpiece 3 may be formed in various structures, and one structure of the mouthpiece is described in conjunction with FIGS. 1 and 2 hereinafter.

A liquid collecting chamber 31 in communication with the vapor pipe 12 is provided in the mouthpiece, and a chamber wall of the liquid collecting chamber 31 is provided with an air outlet hole 32 for flowing out of airflow, which allows condensed tobacco liquid to be collected in the liquid collecting chamber 31 in the case that the vapor atomized by the electric heating wire assembly flows via the vapor pipe 12 to the air outlet hole 32.

Preferably, the mouthpiece 3 and the liquid storage sleeve 11 are detachably connected. In this way, the mouth piece 3 may be removed for cleaning smoke solution reserved in the liquid collecting chamber, which may prevent the smoke solution from being smoked by the user when the user is smoking.

Preferably, an annular boss 33 for isolating the tobacco liquid is provided at one side, at a periphery of the air outlet hole 32 and faces to the vapor pipe 12, of the chamber wall of the liquid collecting chamber 31, or a liquid absorbing piece (not shown in Figure) is provided in the liquid collecting chamber 31, and the liquid absorbing piece is made of a liquid-absorbable material. Apparently, the above two solutions may be adopted at the same time to better prevent user smoking the tobacco liquid which has not been able to atomized.

In the present application, one end of the vapor pipe 12 in the liquid storage assembly 1 is in communication with the vapor hole on the end surface of the cup cover. During assembly, in the case that the vapor pipe is inclined, the tobacco liquid is easily exuded from the place where the vapor pipe is in communication with the vapor hole in the using process of the electronic cigarette, thereby resulting liquid leakage. A liquid storage assembly which can prevent the liquid leakage is described in conjunction with FIGS. 1 and 2 hereinafter.

As shown in FIGS. 1 and 2, a positioning column 14 is provided at one end, close to the mouthpiece 3, of the vapor pipe 12. The vapor pipe 12 runs through a center axis of the positioning column 14. Preferably, the vapor pipe 12 and the positioning column 14 are formed integrally so that the vapor pipe 12 is in parallel with the center axis of the positioning column 14.

An outer side wall of the positioning column 14 is nested into the liquid storage sleeve 11 and abuts against an inner side wall of the liquid storage sleeve 11, such that the vapor pipe 12 is fixed in parallel with the inner side wall of the liquid storage sleeve 11. A second annular groove 141 is further provided on the outer side wall of the positioning column 14, and a sealing ring 15 elastically abutting against the inner side wall of the liquid storage sleeve 11 is sleeved on the second annular groove 141, thereby preventing the tobacco liquid in the liquid storage chamber from exuding via a clearance between the positioning column 14 and the liquid storage sleeve 11, further causing liquid leakage.

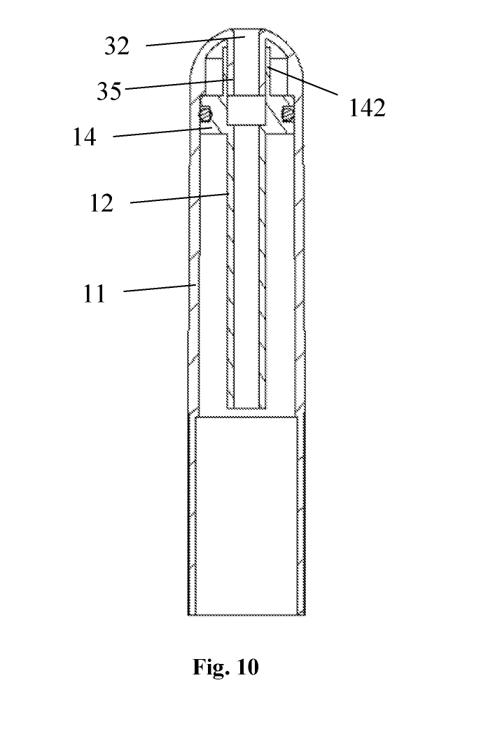

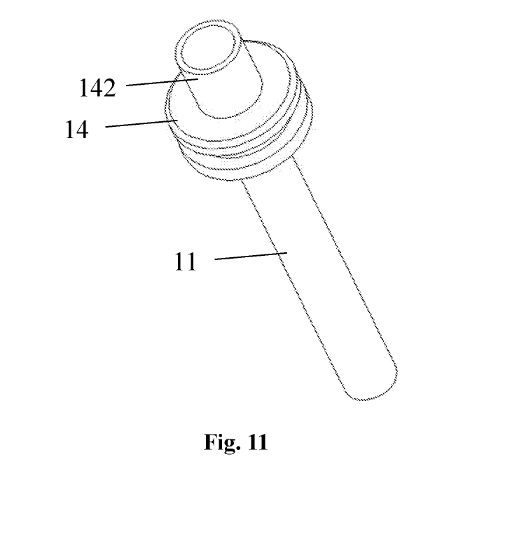

Preferably, as shown in FIGS. 10 and 11, FIG. 10 is a cross-sectional view showing another structure of a liquid storage assembly in the atomization assembly according to the present application, and FIG. 11 is a schematic view showing the structures of a vapor pipe, a positioning column, and a positioning ring in the liquid storage assembly in FIG. 10. An air outlet hole 32 is provided on the mouthpiece 3 at a position corresponding to a center axis of the liquid storage sleeve 11, and an annular positioning boss 35 extending along the center axis of the liquid storage sleeve 11 is provided at one side, facing to the vapor pipe 12, of a periphery of the air outlet hole 32.

The positioning ring 142 is further provided at an end surface of one end, close to the mouthpiece 3, of the positioning column 14, and one end, away from the positioning column 14, of the positioning ring 142 extends to the annular positioning boss 35 of the mouthpiece 3 and is sleeve on the annular positioning boss 35, and an inner side wall of the positioning ring 142 and an outer side wall of the annular positioning boss are in an interference fit. Vapor atomized by the electric heating wire assembly passes through the vapor pipe 12 and then flows via the annular positioning boss 35 to the air outlet hole 32 and is smoked by the user.

In this embodiment, the vapor pipe can be parallel to an inner side of the liquid storage sleeve by the cooperation of the annular positioning step on the mouthpiece and the positioning ring around the positioning column when the vapor pipe is assembled inside the liquid storage assembly.

Or, preferably, in this embodiment, the mouthpiece in the liquid storage assembly, the liquid storage sleeve and the vapor pipe are formed integrally, which avoids the vapor pipe to incline during the assembly of the liquid storage sleeve and the vapor pipe.

An electronic cigarette is further provided in the present application, which includes a battery assembly and an atomization assembly connected to each other, and the battery assembly is a prior art, which is not described in detail hereinafter. The atomization assembly includes a liquid storage assembly and an atomization core assembly.

The liquid storage assembly includes a liquid storage sleeve having a first end and a second end opposite to each other. A mouthpiece is provided at the first end of the liquid storage sleeve, and a liquid filling port is formed at the end surface of the second end of the liquid storage sleeve. A vapor pipe in communication with the mouthpiece is provided in the liquid storage sleeve, and a liquid storage chamber for storing the tobacco liquid is formed between the liquid storage sleeve and the vapor pipe.

The atomization core assembly includes an atomizing seat, an electric heating wire element supported in an atomization space at one end of the atomizing seat for atomizing the tobacco liquid, and an electric connection element fixed at another end of the atomizing seat for being electrically connected to the electric heating wire assembly. A cup cover connected to the atomizing seat in an insertion manner is provided at one end, where the electric heating wire assembly is provided, of the atomizing seat.

One end, where the cup cover is provided, of the atomization core assembly, is inserted into the liquid storage sleeve and abuts against the vapor pipe at one end away from the mouthpiece. An opening of the liquid storage is covered by an end surface of the cup cover. A liquid guiding hole is provided at an area on end surface of the cup cover corresponding to the liquid storage chamber. The liquid guiding plate is arranged at one side, away from the liquid storage chamber, of the end surface of the cup cover, and is made of a liquid-absorbable material. The liquid guiding plate fits the end surface of the cup cover and covers the liquid guiding hole, which allows the liquid guiding hole and the liquid guiding plate to guide the tobacco liquid in the liquid storage chamber to the electric heating wire assembly to be atomized.

A specific structure of the atomization assembly of the electronic cigarette may refer to the specific structure of the above atomization assembly. Since the structure of the atomization assembly of the electronic cigarette is the same as the structure of the above atomization assembly, the electronic cigarette has the same technical effects.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. An atomization assembly for being assembled with a battery assembly to form an electronic cigarette, wherein the atomization assembly comprises a liquid storage assembly and an atomization core assembly;
the liquid storage assembly comprises a liquid storage sleeve having a first end and a second end opposite to each other, a mouthpiece is provided at the first end of the liquid storage sleeve, a liquid filling port is formed at an end surface of the second end of the liquid storage sleeve, a vapor pipe in communication with the mouthpiece is provided in the liquid storage sleeve, and a liquid storage chamber for storing tobacco liquid is formed between the liquid storage sleeve and the vapor pipe;
the atomization core assembly comprises an atomizing seat, an electric heating wire element supported in an atomization space at one end of the atomizing seat for atomizing the tobacco liquid, and an electric connection element fixed at another end of the atomizing seat for being electrically connected to the electric heating wire assembly, and a cup cover connected to the atomizing seat in an insertion manner is provided at one end, where the electric heating wire assembly is provided, of the atomizing seat; and
one end, where the cup cover is provided, of the atomization core assembly, is inserted into the liquid storage sleeve and abuts against the vapor pipe at one end away from the mouthpiece, an opening of the liquid storage is covered by an end surface of the cup cover, a liquid guiding hole is provided at an area of the end surface of the cup cover corresponding to the liquid storage chamber, a vapor hole in communication with the vapor pipe and the atomization space is provided at the end surface of the cup cover corresponding to the vapor pipe, the liquid guiding plate is arranged at one side, away from the liquid storage chamber, of the end surface of the cup cover, and is made of a liquid-absorbable material, the liquid guiding plate fits the end surface of the cup cover and covers the liquid guiding hole, which allows the liquid guiding hole and the liquid guiding plate to guide the tobacco liquid in the liquid storage chamber into the electric heating wire assembly to be atomized.

2. The atomization assembly according to claim 1, wherein the atomizing seat comprises an atomizing seat body and a connecting sleeve sleeved on an outer side wall of the atomizing seat body, the electric heating wire assembly is supported in the atomizing seat body, the connecting sleeve has one end extending out of one end, away from the liquid storage assembly, of the atomizing seat body, and a connection structure detachably connected to the battery assembly is provided at the end of the connecting sleeve; and
the cup cover comprises an end wall having the end surface and a side wall formed by a periphery of the end wall extending towards the connecting sleeve, the side wall is sleeved on the connecting sleeve by an interference fit, a position-limiting protruding portion abutting against an end portion of the side wall of the cup cover is provided on an outer side wall of the connecting sleeve, and the liquid guiding plate is clamped between one end, close to the liquid storage sleeve, of the connecting sleeve and the end surface of the cup cover.

3. The atomization assembly according to claim 2, wherein a first annular groove is provided at an outer side wall, in the liquid storage sleeve, of the connecting sleeve; and
the atomization core assembly further comprises a sealing ring sleeved on the first annular groove and elastically pressing against an inner side wall of the liquid storage sleeve.

4. The atomization assembly according to claim 2, wherein the connecting sleeve and the liquid storage sleeve are connected in an insertion manner by an interference fit, a clearance is formed between the side wall of the cup cover and the liquid storage sleeve, and a width of the clearance is less than 0.1 mm.

5. The atomization assembly according to claim 1, wherein the atomization core assembly further comprises a sealing seat which is hollow and cylindrical on the whole and has a first end and a second end opposite to each other;
the first end of the sealing seat is inserted into the vapor hole of the cup cover, the second end abuts against one end of the vapor pipe, a diameter of an outer side wall of the second end of the sealing seat is greater than a diameter of an outer side wall of the first end, which allows an annular boss to be formed at an outer side wall of the sealing seat, and the end surface of the cup cover presses against the annular boss, which allows the sealing seat to press onto the vapor pipe and elastically press against the vapor pipe.

6. The atomization assembly according to claim 5, wherein the liquid guiding plate is elastically sleeved on the first end of the sealing seat.

7. The atomization assembly according to claim 2, wherein the atomizing seat body is a polyvinyl chloride silicone fiberglass tube or a ceramic tube, and one end of the atomizing seat body is provided with two opposite and apart U-shaped concave portions both extending in a side away from the mouth piece; and
the electric heating wire assembly is of a U-shape, which comprises a first end and a second end in parallel with each other, a middle section for connecting the first end and the second end, the middle section of the electric heating wire assembly is supported at bottoms of the two U-shaped concave portions of the atomizing seat body, the first end and the second end of the electric heating wire assembly are respectively located in the two U-shaped concave portions of the atomizing seat body, and end surfaces of the first end and the second end of the electric heating wire assembly are directed at areas, corresponding to the liquid storage chamber, on the end surface of the cup cover through the liquid guiding plate.

8. The atomization assembly according to claim 2, wherein the atomizing seat body is a polyvinyl chloride silicone fiberglass tube or a ceramic tube, and two opposite and apart through-holes are provided with in a side wall of an atomizing seat body; and
the electric heating wire assembly is of a U-shape, which comprises a first end and a second end in parallel with each other, and a middle section for connecting the first end and the second end, the middle section of the electric heating wire assembly passes through the two through-holes of the atomizing seat body, a first end and a second end of the electric heating wire assembly are located in parallel outside the side wall of the atomizing seat body, and end surfaces of the first end and the second end of the electric heating wire assembly are directed at areas, corresponding to the liquid storage chamber, on an end surface of the cup cover through the liquid guiding plate.

9. The atomization assembly according to claim 2, wherein the atomizing seat body is a polyvinyl chloride silicone fiberglass tube or a ceramic tube, and two opposite apart concave portions are provided at one end of an atomizing seat body; and
an electric heating wire element is cylindrical, two ends of the electric heating wire assembly are mounted in the two concave portions of the atomizing seat body, and end surfaces of a first end and a second end of the electric heating wire assembly are directed at areas, corresponding to the liquid storage chamber, on an end surface of the cup cover through the liquid guiding plate.

10. The atomization assembly according to claim 1, wherein a liquid collecting chamber in communication with the vapor pipe is provided in the mouthpiece, and a chamber wall of the liquid collecting chamber is provided with an air outlet hole for flowing out of airflow, which allows condensed tobacco liquid to be collected in the liquid collecting chamber in the case that the vapor atomized by the electric heating wire assembly flows via the vapor pipe into the air outlet hole.

11. The atomization assembly according to claim 10, wherein one side at a periphery of the air outlet hole and facing to the vapor pipe, of the chamber wall of the liquid collecting chamber is provided with an annular boss for isolating the tobacco liquid, and/or a liquid absorbing piece made of a liquid-absorbable material is provided in the liquid collecting chamber.

12. The atomization assembly according to claim 1, wherein a positioning column is arranged around one end, close to the mouthpiece, of the vapor pipe, and the vapor pipe runs through a center axis of the positioning column; and
an outer side wall of the positioning column is inserted into the liquid storage sleeve, for fixing the vapor pipe in parallel with the inner side wall of the liquid storage sleeve, a second annular groove is provided in the outer side wall of the positioning column, and a sealing ring elastically abutting against the inner side wall of the liquid storage sleeve is sleeved in the second annular groove.

13. The atomization assembly according to claim 12, wherein an air outlet hole is provided in the mouthpiece at a position corresponding to a center axis of the liquid storage sleeve, and an annular positioning boss extending along the center axis of the liquid storage sleeve is provided at one side, facing to the vapor pipe, of a periphery of the air outlet hole; and
a positioning ring is provided at an end surface of one end, close to the mouthpiece, of the positioning column, and one end, away from the positioning column, of the positioning ring extends to the annular positioning boss of the mouthpiece and is sleeved on the annular positioning boss, and an inner side wall of the positioning ring and an outer side wall of the annular positioning boss are tightly clamped by an interference fit.

14. The atomization assembly according to claim 1, wherein the mouthpiece, the liquid storage sleeve and the vapor pipe are formed integrally.

15. The atomization assembly according to claim 1, wherein an annular position-limiting step is provided at a position, corresponding to the end surface of the cup cover, on an inner side wall of the liquid storage sleeve, and a periphery of the end surface of the cup cover presses against the position-limiting step.

16. The atomization assembly according to claim 1, wherein the liquid storage sleeve is made of a light-permeable material.

17. The atomization assembly according to claim 1, wherein a plurality of liquid guiding holes are provided, and the plurality of liquid guiding holes are arranged around a the vapor hole and form an annular shape.

18. The atomization assembly according to claim 1, wherein a diameter of each of the liquid guiding holes is less than 1.5 mm.

19. The atomization assembly according to claim 1, wherein an included angle formed between an extending direction of each of the liquid guiding holes and an extending direction of the liquid storage chamber is greater than 30 degrees.

20. An electronic cigarette, comprising a battery assembly and an atomization assembly connected to each other, wherein the atomization assembly is assembled with a battery assembly to form an electronic cigarette, and the atomization assembly comprises a liquid storage assembly and an atomization core assembly;
the liquid storage assembly comprises a liquid storage sleeve having a first end and a second end opposite to each other, a mouthpiece is provided at the first end of the liquid storage sleeve, a liquid filling port is formed at an end surface of the second end of the liquid storage sleeve, a vapor pipe in communication with the mouthpiece is provided in the liquid storage sleeve, and a liquid storage chamber for storing tobacco liquid is formed between the liquid storage sleeve and the vapor pipe;
the atomization core assembly comprises an atomizing seat, an electric heating wire element supported in an atomization space at one end of the atomizing seat for atomizing the tobacco liquid, and an electric connection element fixed at another end of the atomizing seat for being electrically connected to the electric heating wire assembly, and a cup cover connected to the atomizing seat in an insertion manner is provided at one end, where the electric heating wire assembly is provided, of the atomizing seat; and
one end, where the cup cover is provided, of the atomization core assembly, is inserted into the liquid storage sleeve and abuts against the vapor pipe at one end away from the mouthpiece, an opening of the liquid storage is covered by an end surface of the cup cover, a liquid guiding hole is provided at an area of the end surface of the cup cover corresponding to the liquid storage chamber, a vapor hole in communication with the vapor pipe and the atomization space is provided at the end surface of the cup cover corresponding to the vapor pipe, the liquid guiding plate is arranged at one side, away from the liquid storage chamber, of the end surface of the cup cover, and is made of a liquid-absorbable material, the liquid guiding plate fits the end surface of the cup cover and covers the liquid guiding hole, which allows the liquid guiding hole and the liquid guiding plate to guide the tobacco liquid in the liquid storage chamber into the electric heating wire assembly to be atomized.
